(19) United States
(12) Patent Application Publication
(10) Pub. No.: US 2023/0186237 A1
(43) Pub. Date: Jun. 15, 2023

(54) ITEM WAREHOUSING METHOD, DEVICE AND NON-TRANSITORY COMPUTER-READABLE STORAGE MEDIUM

(71) Applicant: BEIJING JINGDONG ZHENSHI INFORMATION TECHNOLOGY CO., LTD., BEIJING (CN)

(72) Inventors: Wenxiang YANG, BEIJING (CN); Kun WANG, BEIJING (CN)

(21) Appl. No.: 17/999,150

(22) PCT Filed: May 11, 2021
(86) PCT No.: PCT/CN2021/092920

§ 371 Date: Nov. 17, 2022

(30) Foreign Application Priority Data
May 20, 2020 (CN) 202010432371.2

(51) Int. Cl. G06Q 10/0875

(52) U.S. Cl. CPC G06Q 10/0875

(57) ABSTRACT

A warehousing method and apparatus for goods, and a non-volatile computer-readable storage medium, which relate to the technical field of warehousing. The method includes: in response to the reception of warehousing list data, splitting the warehousing list data into a plurality of pieces of task list data according to logistic storage attributes of goods to be warehoused in the warehousing list data; according to at least one of a quality guarantee period parameter, a category parameter and a weight parameter, and on the basis of an arrangement sequence of storage positions in a storage area, allocating storage positions to goods in the task list data; and warehousing the goods according to an allocation result.

### CROSS-REFERENCE TO RELATED APPLICATIONS

The present disclosure is based on and claims priority of Chinese application for invention No. 202010432371.2, filed on May 20, 2020, the disclosure of which is hereby incorporated into this disclosure by reference in its entirety.

### TECHNICAL FIELD

The present disclosure relates to the technical field of warehousing, and in particular, to an item warehousing method, device and non-transitory computer-readable storage medium.

### BACKGROUND

The item warehousing is the first step of warehousing and storage activities. For example, cold-chain products need to be warehoused in a low temperature environment (such as −18° C.), and operators need to rest in a relatively comfortable environment once upon they operate for a period of time. This requires efficient operation and connection of various links in the warehousing and storage of cold-chain products.

In the related art, items to be warehoused are manually checked and stored in corresponding storage locations.

### SUMMARY

According to some embodiments of the present disclosure, there is provided an item warehousing method, comprising: in response to receiving warehousing sheet data, according to logistics storage attributes of various items to be warehoused in the warehousing sheet data, splitting the warehousing sheet data into a plurality of worksheets; according to at least one of a shelf life parameter, a category parameter, or a weight parameter, and according to an arrangement sequence of storage locations in a storage area, allocating storage locations for the items to be warehoused in each worksheet of the plurality of worksheets; according to the result of the allocating, performing a warehousing process on items to be warehoused in the warehousing sheet data.

In some embodiments, allocating storage locations for the items to be warehoused in each worksheet of the plurality of worksheets comprises: according to relevant data of warehoused items, for each item to be warehoused, searching for a matched warehoused item matching the shelf life parameter of the item to be warehoused; allocating a storage location where the matched warehoused item is located to an item to be warehoused corresponding to the matched warehoused item.

In some embodiments, allocating storage locations for the items to be warehoused in each worksheet of the plurality of worksheets comprises: according to relevant data of warehoused items, for each item to be warehoused, searching for a matched warehoused item matching the category parameter of the item to be warehoused; allocating a storage location where the matched warehoused item is located to an item to be warehoused corresponding to the matched warehoused item.

In some embodiments, allocating storage locations for the items to be warehoused in each worksheet of the plurality of worksheets comprises: for each item to be warehoused, determining specific gravity information of the item to be warehoused according to a weight parameter and package size information of the item to be warehoused; allocating a storage location for the item to be warehoused according to the specific gravity information.

In some embodiments, allocating storage locations for the items to be warehoused in each worksheet of the plurality of worksheets comprises: in a case where the storage area comprises a plurality of sequentially arranged sub-storage areas, and each sub-storage area of the plurality of sequentially arranged sub-storage areas comprises a plurality of sequentially arranged storage lanes, for each item to be warehoused, according to the category parameter of the item to be warehoused, determining a matched warehoused item matching the item to be warehoused; if the storage locations in a storage lane where the matched warehoused item is located are not full, allocating a storage location in the storage lane where the matched warehoused item is located to the item to be warehoused corresponding to the matched warehoused item; if the storage locations in the storage lane where the matched warehoused item is located are all full, according to the arrangement of the sub-storage areas, allocating a storage location in a storage lane of another sub-storage area to the item to be warehoused corresponding to the matched warehoused item.

In some embodiments, allocating a storage location in a storage lane of another sub-storage area to the item to be warehoused corresponding to the matched warehoused item comprises: if storage locations in a storage lane with the same sequence number as the storage lane where the matched warehoused item is located are not full, allocating a storage location in the storage lane with the same sequence number to the item to be warehoused corresponding to the matched warehoused item; if the storage locations in the storage lane with the same sequence number as the storage lane where the matched warehoused item is located are all full, allocating a storage location to the item to be warehoused according to the arrangement sequence of the sub-storage areas and the arrangement sequence of the storage lanes.

In some embodiments, allocating storage locations for the items to be warehoused in each worksheet of the plurality of worksheets comprises: in a case where the storage area comprises a plurality of sequentially arranged sub-storage areas, each sub-storage area of the plurality of sequentially arranged sub-storage areas comprising a plurality of sequentially arranged storage lanes, and each storage lane comprising a plurality of sequentially arranged racks, allocating a storage location for the item to be warehoused according to the arrangement sequence of the racks.

In some embodiments, allocating storage locations for the items to be warehoused in each worksheet of the plurality of worksheets comprises: if the rack in the storage area comprises a plurality of layers, allocating a storage location for the item to be warehoused according to priorities of the plurality of layers, wherein layers closer to the middle of the rack have higher priorities than those farther from the middle of the rack.

In some embodiments, according to the result of the allocating, performing a warehousing process on items to be warehoused in the warehousing sheet data comprises: for each worksheet of the plurality of worksheets, according to the result of the allocating, putting items to be warehoused in the worksheet to corresponding storage locations on a rack; for each item category in the worksheet, obtaining an actual weight of items of this category on the rack through a weight sensor; according to the obtained actual weight, determining a quantity of warehoused items of this category; if the quantity of warehoused items is less than a registered quantity of a corresponding category in a corresponding worksheet, determining extra items of the corresponding category in the corresponding worksheet as new items to be warehoused; re-allocating a storage location for the new items to be warehoused.

In some embodiments, according to the result of the allocating, performing a warehousing process on items to be warehoused in the warehousing sheet data comprises: according to the result of the allocating, putting items to be warehoused of each category in the warehousing sheet data to a corresponding storage location for the category on a rack; for each item category in the warehousing sheet data, obtaining an actual weight of items of this category on the rack through a weight sensor; according to the obtained actual weight, determining a quantity of warehoused items of this category; for any item category, if the quantity of warehoused items of this category is less than a registered quantity of items of this category in the warehousing sheet data, determining extra items of this category as items that have not been put away; according to the result of the allocating, putting the items that have not been put away to a corresponding storage location for the items that have not been put away.

In some embodiments, according to the result of the allocating, performing a warehousing process on items to be warehoused in the warehousing sheet data comprises: according to the result of the allocating, putting items to be warehoused in the warehousing sheet data to corresponding storage locations on a rack; for any item, if there is a difference between relevant information of the item on the rack and relevant information of an item to be warehoused in the warehousing sheet data corresponding to the item on the rack, checking the item on the rack; if there is not a difference between relevant information of the item on the rack and relevant information of an item to be warehoused in the warehousing sheet data corresponding to the item on the rack, uploading the relevant information of the item on the rack.

In some embodiments, the logistical storage attributes comprise at least one of an item storage temperature parameter or a package size parameter.

In some embodiments, according to the result of the allocating, performing a warehousing process on items to be warehoused in the warehousing sheet data comprises: controlling a transmission device to drive a rack to rotate, so as to store the items to be warehoused in their corresponding storage locations on the rack.

According to other embodiments of the present disclosure, there is provided an item warehousing device, comprising: a splitting unit for, in response to receiving warehousing sheet data, according to logistics storage attributes of various items to be warehoused in the warehousing sheet data, splitting the warehousing sheet data into a plurality of worksheets; a allocation unit for, according to at least one of a shelf life parameter, a category parameter, or a weight parameter, and according to an arrangement sequence of storage locations in a storage area, allocating storage locations for the items to be warehoused in each worksheet of the plurality of worksheets; a processing unit, for according to the result of the allocating, performing a warehousing process on items to be warehoused in the warehousing sheet data.

In some embodiments, the allocation unit is used for, according to relevant data of warehoused items, for each item to be warehoused, searching for a matched warehoused item matching the shelf life parameter of the item to be warehoused; allocating a storage location where the matched warehoused item is located to an item to be warehoused corresponding to the matched warehoused item.

In some embodiments, the allocation unit is used for, according to relevant data of warehoused items, for each item to be warehoused, searching for a matched warehoused item matching the category parameter of the item to be warehoused; allocating a storage location where the matched warehoused item is located to an item to be warehoused corresponding to the matched warehoused item.

In some embodiments, the allocation unit is used for, for each item to be warehoused, determining specific gravity information of the item to be warehoused according to a weight parameter and package size information of the item to be warehoused; allocating a storage location for the item to be warehoused according to the specific gravity information.

In some embodiments, the storage area comprises a plurality of sequentially arranged sub-storage areas, and the sub-storage area comprises a plurality of sequentially arranged storage lanes; the allocation unit is used for, for each item to be warehoused, according to the category parameter of the item to be warehoused, determining a matched warehoused item matching the item to be warehoused; if the storage locations in a storage lane where the matched warehoused item is located are not full, allocating a storage location in the storage lane where the matched warehoused item is located to the item to be warehoused corresponding to the matched warehoused item; if the storage locations in the storage lane where the matched warehoused item is located are all full, according to the arrangement of the sub-storage areas, allocating a storage location in a storage lane of another sub-storage area to the item to be warehoused corresponding to the matched warehoused item.

In some embodiments, if the storage locations in a storage lane with the same sequence number as the storage lane where the matched warehoused item is located are not full, the allocation unit allocates a storage location in the storage lane with the same sequence number to the item to be warehoused corresponding to the matched warehoused item; if the storage locations in the storage lane with the same sequence number as the storage lane where the matched warehoused item is located are all full, allocates a storage location to the item to be warehoused according to the arrangement sequence of the sub-storage areas and the arrangement sequence of the storage lanes.

In some embodiments, the storage area comprises a plurality of sequentially arranged sub-storage areas, each sub-storage area of the plurality of sequentially arranged sub-storage areas comprising a plurality of sequentially arranged storage lanes, and each storage lane comprising a plurality of sequentially arranged racks, the allocation unit is used for allocating a storage location to the item to be warehoused according to the arrangement sequence of the racks.

In some embodiments, the rack in the storage area has a plurality of layers; the allocation unit is used for allocating a storage location for the item to be warehoused according to priorities of the plurality of layers, wherein layers closer to the middle of the rack have higher priorities than those farther from the middle of the rack.

In some embodiments, the processing unit is used for, for each worksheet of the plurality of worksheets, according to the result of the allocating, putting items to be warehoused in the worksheet to corresponding storage locations on a rack; for each item category in the worksheet, obtaining an actual weight of items of this category on the rack through a weight sensor; according to the obtained actual weight, determining a quantity of warehoused items of this category; if the quantity of warehoused items is less than a registered quantity of a corresponding category in a corresponding worksheet, determining extra items of the corresponding category in the corresponding worksheet as new items to be warehoused; re-allocating a storage location for the new items to be warehoused.

In some embodiments, the processing unit is used for, according to the result of the allocating, putting items to be warehoused of each category in the warehousing sheet data to a corresponding storage location for the category on a rack; for each item category in the warehousing sheet data, obtaining an actual weight of items of this category on the rack through a weight sensor; according to the obtained actual weight, determining a quantity of warehoused items of this category; for any item category, if the quantity of warehoused items of this category is less than a registered quantity of items of this category in the warehousing sheet data, determining extra items of this category as items that have not been put away; according to the result of the allocating, putting the items that have not been put away to a corresponding storage location for the items that have not been put away.

In some embodiments, the processing unit is used for, according to the result of the allocating, putting items to be warehoused in the warehousing sheet data to corresponding storage locations on a rack; for any item on the rack, if there is a difference between relevant information of the item on the rack and relevant information of an item to be warehoused in the warehousing sheet data corresponding to the item on the rack, checking the item on the rack; if there is not a difference between relevant information of the item on the rack and relevant information of an item to be warehoused in the warehousing sheet data corresponding to the item on the rack, uploading the relevant information of the item on the rack.

In some embodiments, the logistical storage attributes comprise at least one of an item storage temperature parameter or a package size parameter.

In some embodiments, the processing unit controls a transmission device to drive a rack to rotate, so as to store the items to be warehoused to their corresponding storage locations on the rack.

According to other embodiments of the present disclosure, there is provided an item warehousing device, comprising: a memory; a processor coupled to the memory, the processor configured to, based on instructions stored in the memory, carry out the item warehousing method according to any one of the above embodiments.

In some embodiments, the item warehousing device further comprises: a weight sensor for detecting an actual weight of an item on a rack.

In some embodiments, the item warehousing device further comprises: a transmission device for, in response to the control of the processor, driving a rack to rotate, so as to store the items to be warehoused to their corresponding storage locations on the rack.

According to still further embodiments of the present disclosure, there is provided a computer readable storage medium having stored thereon a computer program that, when executed by a processor, implements the item warehousing method according to any one of the above embodiments.

### BRIEF DESCRIPTION OF THE DRAWINGS

The accompanying drawings, which are incorporated in and constitute a portion of this specification, illustrate embodiments of the present disclosure and, together with the description, serve to explain the principles of the present disclosure.

The present disclosure will be more clearly understood from the following detailed description with reference to the accompanying drawings, in which:

FIG. 1 shows a flowchart of an item warehousing method according to some embodiments of the present disclosure;

FIG. 2 shows a flowchart of step 130 in FIG. 1 according to some embodiments of the present disclosure;

FIG. 3 shows a flowchart of step 220 in FIG. 2 according to some embodiments of the present disclosure;

FIG. 4 shows a flowchart of step 340 in FIG. 3 according to some embodiments of the present disclosure;

FIG. 5 shows a schematic diagram of an item warehousing device according to some embodiments of the present disclosure;

FIG. 6 shows a block diagram of the item warehousing device according to some embodiments of the present disclosure;

FIG. 7 shows a block diagram of the item warehousing device according to other embodiments of the present disclosure;

FIG. 8 shows a block diagram of the item warehousing device according to still other embodiments of the present disclosure.

### DETAILED DESCRIPTION

Various exemplary embodiments of the present disclosure will now be described in detail with reference to the accompanying drawings. Notice that, unless otherwise specified, the relative arrangement, numerical expressions and numerical values of the components and steps set forth in these examples do not limit the scope of the invention.

At the same time, it should be understood that, for ease of description, the dimensions of the various parts shown in the drawings are not drawn to actual proportions.

The following description of at least one exemplary embodiment is in fact merely illustrative and is in no way intended as a limitation to the invention, its application or use.

Techniques, methods, and apparatus known to those of ordinary skill in the relevant art may not be discussed in detail, but where appropriate, these techniques, methods, and apparatuses should be considered as part of the specification.

Of all the examples shown and discussed herein, any specific value should be construed as merely illustrative and not as a limitation. Thus, other examples of exemplary embodiments may have different values.

Notice that, similar reference numerals and letters are denoted by the like in the accompanying drawings, and therefore, once an article is defined in a drawing, there is no need for further discussion in the accompanying drawings.

The inventors of the present disclosure have found the following problems existed in the above-mentioned related art: storage locations cannot be reasonably allocated according to item attributes, resulting in low warehousing efficiency.

In view of this, the present disclosure proposes a scheme for item warehousing, which can improve warehousing efficiency.

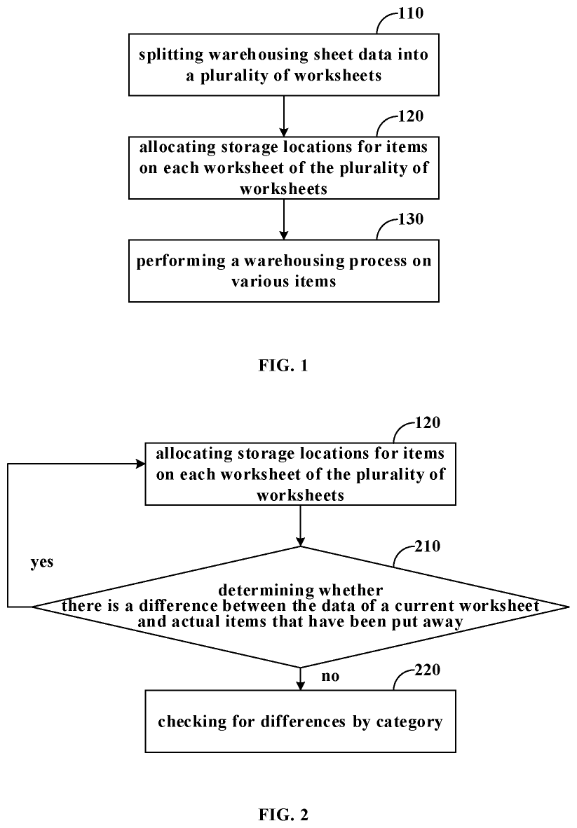

FIG. 1 shows a flowchart of an item warehousing method according to some embodiments of the present disclosure.

As shown in FIG. 1, the method comprises: step 110: splitting warehousing sheet data into a plurality of worksheets; step 120: allocating storage locations for items on each worksheet of the plurality of worksheets; and step 130: performing a warehousing process on the items.

In step 110, in response to receiving warehousing sheet data, according to logistics storage attributes of various items to be warehoused in the warehousing sheet data, the warehousing sheet data is split into a plurality of worksheets. For example, the logistical storage attributes comprise at least one of an item storage temperature parameter or a package size parameter.

In some embodiments, the warehousing sheet data (sheet of items warehoused and put-away) is issued by a WMS (Warehouse Management System). For example, the WMS can determine a corresponding put-away (put items on the rack) strategy based on relevant information (such as category, etc.) of items that have been checked and accepted, and then generate a sheet of items warehoused and put-away. The WMS can issue the sheet of items warehoused and put-away to a WCS (Warehouse Control System).

In some embodiments, the WCS may split the received warehousing sheet into a plurality of worksheets (put-away worksheets). For example, the sheet of items warehoused and put-away received by the WCS contains all the items to be put away (items to be warehoused). According to the logistics attributes of all the items to be put away, the WCS will split the warehousing sheet into several put-away worksheets.

In step 120, according to at least one of a shelf life parameter, a category parameter, or a weight parameter, and according to an arrangement sequence of storage locations in a storage area, storage locations are allocated for items to be warehoused in each worksheet of the plurality of worksheets.

In some embodiments, a WCS performs storage location allocation for items to be put away. For example, a WCS allocates storage locations for all the incoming items (items to be warehoused) according to different allocation strategies. The allocation strategy may comprise a shelf-life allocation strategy, a least storage location strategy, a specific gravity allocation strategy, an even storage location distribution strategy, a rack unit allocation strategy, a layer-height based storage location allocation strategy, and the like.

In some embodiments, the WCS may allocate storage locations in a Goods to Person System to items to be warehoused.

For example, the WMS can treat a goods-to-person system as a storage location, and the WCS can treat a goods-to-person system as a storage area that can be re-divided. The WCS can divide the storage area into a plurality of sub-storage areas CQᵢ, each CQᵢ comprising a plurality of storage lanes XDⱼ, each XDⱼ comprising a plurality of racks Lₖ, each Lₖ having a plurality of layers Xᵤ, and each Xᵤ comprising a plurality of storage locations CWᵥ. Wherein j, k, u, and v are integers equal to or greater than 1.

In some embodiments, the shelf life allocation strategy may be: according to relevant data of warehoused items, for each item to be warehoused, searching for a matched warehoused item matching the shelf life parameter of the item to be warehoused; allocating a storage location where the matched warehoused item is located to the corresponding item to be warehoused. For example, shelf life batch management data (such as, in day, week, month, quarter, half year, or year) of an item can be obtained, and a storage location can be allocated for the item according to the shelf life batch data.

For example, the WCS system can first determine whether there are warehoused items that have been put away and have the same shelf life batch as the item to be warehoused in the goods-to-person system; if there are warehoused items in the same shelf life batch, and the storage locations where these warehoused items are located are not full, the item to be warehoused is put to the storage location until the storage location is full; If there are no warehoused items in the same shelf life batch, the item to be warehoused will be put away according to another strategy.

In some embodiments, the least storage location strategy may be: according to relevant data of warehoused items, for each item to be warehoused, searching for a matched warehoused item matching the category parameter of the item to be warehoused; allocating a storage location where the matched warehoused item is located to the corresponding item to be warehoused.

For example, for each SKU (Stock Keeping Unit), it is determined whether there is a storage location (storing corresponding SKU items) for the SKU in the goods-to-person system and the storage location is not full. If there is a storage location for the SKU and the storage location is not full, the items to be warehoused in the corresponding SKU are allocated to the storage location.

In some embodiments, the specific gravity allocation strategy may be: for each item to be warehoused, determining specific gravity information of the item to be warehoused according to a weight parameter and package size information of the item to be warehoused; allocating a storage location for the item to be warehoused according to the specific gravity information.

For example, items to be warehoused can be categorized into heavy items and light items as follows:
if

$$\frac{m i}{li \times wi \times di} \geq w ,$$

I=Heavy,
   else I=Light

mi is the weight of item I (in kg), li is the length of item I (in mm), wi is the width of item I (in mm), di is the height of item I (in mm), and w is a threshold (in kg/mm³). “Heavy” is a mark for heavy items, and “Light” is a mark for non-heavy items i.e. light items.

In some embodiments, the storage area comprises a plurality of sequentially arranged sub-storage areas, and the sub-storage area comprises a plurality of sequentially arranged storage lanes.

For example, the even storage location distribution strategy may be: for each item to be warehoused, according to the category parameter of the item to be warehoused, determining a matched warehoused item matching the item to be warehoused; if the storage locations in a storage lane where the matched warehoused item is located are not full, allocating a storage location in the storage lane where the matched warehoused item is located to the corresponding item to be warehoused.

If the storage locations in the storage lane where the matched warehoused item is located are all full, according to the arrangement of the sub-storage areas, allocating a storage location in a storage lane of another sub-storage area to the corresponding item to be warehoused.

For example, if the storage locations in a storage lane with the same sequence number as the storage lane where the matched warehoused item is located are not full, allocating a storage location in the storage lane with the same sequence number to the corresponding item to be warehoused; if the storage locations in the storage lane with the same sequence number as the storage lane where the matched warehoused item is located are all full, allocating a storage location to the item to be warehoused according to the arrangement sequence of the sub-storage areas and the arrangement sequence of the storage lanes.

For example, in the even storage location distribution strategy, storage locations can be allocated according to the following priorities: (CQ₁, XD₁)>(CQ₂, XD₁)>(CQ₁, XD₂)>(CQ₂, XD₂)> . . . . In this way, the items can be evenly distributed in the storage lanes of different sub-storage areas, thereby ensuring the uniform distribution of the items, and improving warehousing efficiency.

First, a storage location of warehoused items that are in the same category as the item to be warehoused can be searched in the storage area, and then a storage location can be allocated according to the even storage location distribution strategy.

For example, categories of items that have been put away in various storage locations in the goods-to-person system can be learned through the WCS system, so as to know that items in the same category as the item to be warehoused are stored in (CQ₁, XD₁), but (CQ₁, XD₁) is full; in this case, the allocation priorities of storage locations available for the item to be warehoused are: (CQ₂, XD₁)>(CQ₁, XD₂)>(CQ₂, XD₂)> . . . >(CQ₁, XD₁).

That is to say, with (CQ₁, XD₁) as a reference storage location, according to the arrangement sequence of the sub-storage areas, a storage location is allocated in a storage lane of a sub-storage area other than the sub-storage area where the reference storage location is located. When allocating a storage lane in another sub-storage area, preference is given to a storage lane having the same sequence number as the reference storage location.

In some embodiments, a storage area comprises a plurality of sequentially arranged sub-storage areas, each sub-storage area of the plurality of sequentially arranged sub-storage areas comprising a plurality of sequentially arranged storage lanes, and each storage lane comprising a plurality of sequentially arranged racks. According to the rack unit allocation strategy, a storage location is allocated to the item to be warehoused according to the arrangement sequence of the racks.

For example, the rack unit allocation strategy can set priorities according to rack serial numbers, such as L1>L2> . . . >LK, wherein K is the total number of the racks. In this way, it can be ensured that the rotating racks rotate as few turns as possible to complete the put-away of as many items as possible.

In some embodiments, the rack in the storage area has a plurality of layers. The rack storage location allocation strategy may be: allocating a storage location for the item to be warehoused according to layer priorities. For example, layers closer to the middle of the rack have higher priorities than those farther from the middle of the rack.

For example, the rack layer based allocation strategy can set layer priorities according to the principle of descending from the middle to the upper and lower sides. Storage location priorities can be set according to the arrangement sequence of storage locations on a rack layer. For example, storage location priorities can be set as follows: CW₁>CW₂> . . . CWᵥ, wherein V is the number of storage locations on a rack layer. Different allocation strategies can be set depending on whether the number of rack layers is odd or even.

In some embodiments, when the number u of rack layers is an even number, the highest layer has the lowest priority. For example, the priorities can be set as: X_{(roundup Cu/2))}>X_{(roundup Cu/2)+1)}>X_{(roundup (u/2)-1)}>X_{(roundup(u/2)+2)}>X_{(roundup(u/2)-2)}>Xᵤ, wherein roundup ( ) rounds a number up. For example, if the number of rack layers is an even number u=6, the priorities can be set as follows: X₃>X₄>X₂>X₅>X₁>X₆.

In some embodiments, if the number u of rack layers is an odd number, the lowest layer has the lowest priority. For example, the priorities can be set as follows: X_{(roundup(u/2))}>X_{(roundup(u/2)+1)}>X _{(roundup (u/2)-1)}>X_{(roundup (u/2)+2)}>X_{(roundup(u/2)-2)} . . . >X₁. number of rack layers is an odd number u=5, the priorities can be set as follows: X₃>X₄>X₂>X₅>X₁.

In this way, rack layers in the middle of the rack have moderate height, and the storage locations on these layers are preferentially allocated, which can improve the efficiency of storage.

In step 130, according to the result of the allocating, a warehousing process is performed on items to be warehoused in the warehousing sheet data. For example, the racks in the storage area are rotatable racks. In this way, the racks can be driven to rotate by controlling a transmission device, so as to store the items to be warehoused to their corresponding storage locations on the racks.

In some embodiments, step 130 may be implemented according to the embodiment shown in FIG. 2.

FIG. 2 shows a flowchart of step 130 in FIG. 1 according to some embodiments of the present disclosure.

As shown in FIG. 2, in addition to step 110 (not shown in the figure) and step 120 in FIG. 1, step 130 comprises: step 210, determining whether there is a difference between the data of a current worksheet and actual items that have been put away; and step 220, checking for differences by category.

After step 120, the following steps may be performed: sending allocated storage location information; issuing a device movement instruction; prompting item information; and returning put-away completion information.

In the step of sending allocated storage locations information, the WCS may send allocated storage location information corresponding to a worksheet to the goods-to-person system.

In the step of issuing a device movement instruction, the goods-to-person system issues a device movement instruction according to the worksheet.

In some embodiments, the goods-to-person system performs integration processing on all the items to be put away according to their allocated storage locations according to the put-away worksheet. For example, the integration process may comprise: arranging the corresponding storage locations of all the items to be warehoused in each storage lane in sequence according to the rack sequence, so that the rotating racks in each storage lane can be rotated once to sequentially put all the items to be put away on the racks; integrating different items to be put on the same rack, so that the rotating racks can be rotated once to complete the put-away of all the items on the same rack.

In the step of prompting item information, an electronic display system prompts the information of the items that have been put away. For example, when a rotatable rack of a storage lane is rotated to a rack for the item to be put away, an automatic door of the rotatable rack is opened (each storage lane can correspond to an automatic door). Relevant information of the items to be put on the corresponding rack (such as item names, quantities, specification models, product codes, etc.), and corresponding rack layer numbers and storage location information are displayed through a display screen (each storage lane can correspond to a display screen, which can be disposed near the automatic door).

For example, an operator can be prompted of the logistics attribute information of the items to be put on the rack according to the electronic display system; scan item codes of the items to be put on the rack and complete the put-away of the items.

In the step of returning put-away completion information, the goods-to-person system puts the items that have been put away and returns information on put-away completion to the WCS.

In step 210, it is determined whether there is a difference between the data of a current worksheet and actual items that have been put away; If there is a difference, step 120 is executed again; if there is not a difference, step 220 is executed.

In some embodiments, for each item category on a worksheet, an actual weight of items of this category on the rack is obtained through a weight sensor; according to the obtained actual weight, a quantity of warehoused items of this category is determined; if this quantity is less than a registered quantity of the corresponding category in the corresponding worksheet, extra items in the corresponding category in the corresponding worksheet data are determined as new items to be warehoused.

For example, after the put-away of an item, a total weight of the item on the rack can be measured by a weight sensor, and compared with a weight parameter in the relevant information of the item (such as logistics attributes); a theoretical put-away quantity (warehousing quantity) of the item is calculated and compared with a planned put-away quantity (registered quantity).

If there is no difference between the two quantities, it will prompt that this item in the corresponding worksheet data has been put away correctly; if there is a difference between the two quantities, the electronic display system will prompt the difference in quantity, and a check will be performed for the item corresponding to the difference in quantity; the above steps are repeated until the put-away of all the items of the rack is completed, and then relevant information about the completion is returned to the WCS.

In some embodiments, it can be determined whether there is a difference between the items already put on a current rack and the items to be put away in a corresponding worksheet. The WCS determines whether there is a difference in the number of items that have been put away; if there is a difference, a storage location will be re-allocated for the different number of items, and the above steps are repeated to carry out the corresponding put-away operation; if there is no difference, the method proceeds to the subsequent operations.

In this way, worksheet-based difference detection is completed. Difference detection can be also performed by category.

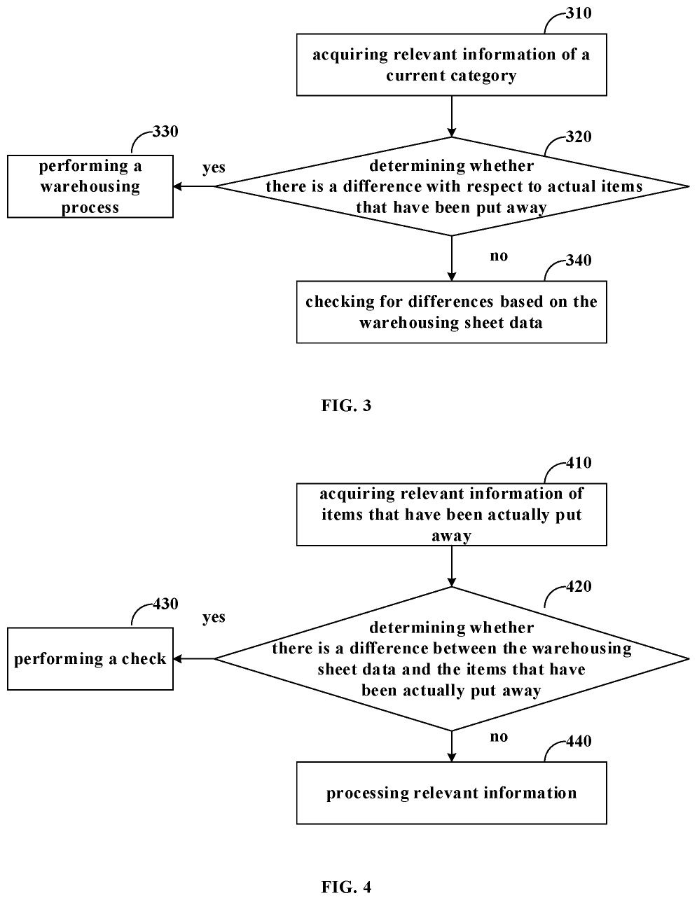

In step 220, difference is detected by category. For example, step 220 can be implemented according to the embodiment shown in FIG. 3.

FIG. 3 shows a flowchart of step 220 in FIG. 2 according to some embodiments of the present disclosure.

As shown in FIG. 3, step 220 comprises: step 310, acquiring relevant information of a current category; step 320, determining whether there is a difference with respect to actual items that have been put away; step 330: performing a warehousing process; and step 340, checking for differences based on the warehousing sheet data.

In step 310, the WCS may obtain relevant information of items that have been put away of each category, such as a weight parameter, a registered quantity, and the like.

In step 320, it is determined whether there is a difference between relevant information of items of this category and relevant information of items that have been actually put away; If there is a difference, step 330 is executed; if there is not a difference, step 340 is executed.

For example, for each category of items in the warehousing sheet data, after putting items to be warehoused of this category into a corresponding storage location on a rack according to the result of the allocating, an actual weight of the items of this category on the rack is obtained using a weight sensor; according to the obtained actual weight, a quantity of the warehoused items of this category is determined; it is then determined whether there is a difference between the quantity of the warehoused items and a registered quantity of a corresponding category in the warehousing sheet data.

In step 330, if the quantity of the warehoused items is less than a registered quantity of the corresponding category in the warehousing sheet data, extra items in the warehousing sheet data are determined as items that have not been put away. according to the result of the allocating, the items that have not been put away are put to a corresponding storage location on the rack.

For example, the goods-to-person system re-issues a device movement instruction according to the worksheet, and a corresponding rack can be rotated to complete the put-away of items corresponding to the different quantity.

In some embodiments, it can be determined whether the warehousing task of a current SKU item is completed (whether there is a quantity difference); if it is not completed (there is a quantity difference), the goods-to-person system will issue a device movement instruction according to a worksheet to put the SKU item away; if it is completed (there is no quantity difference), the method proceed to the subsequent operations; the above steps until the put-away of all SKUs is completed.

In this way, category-based difference detection is completed. Difference detection can also be performed based on the warehousing sheet data.

In step 340, difference is detected based on the warehousing sheet data. For example, step 340 can be implemented according to the embodiment shown in FIG. 4.

FIG. 4 shows a flowchart of step 340 in FIG. 3 according to some embodiments of the present disclosure.

As shown in FIG. 4, step 340 comprises: step 410: acquiring relevant information of items that have been actually put away; step 420: determining whether there is a difference between the warehousing sheet data and the items that have been actually put away; step 430: performing a check; and step 440: processing relevant information.

In step 410, the WCS may obtain relevant information of items to be put away in the warehousing sheet data.

In step 420, it is determined whether there is a difference between relevant information of items to be put away in the warehousing sheet data and relevant information of items that have been actually put away. If there is a difference, step 430 is executed; if there is not a difference, step 440 is executed.

In some embodiments, after items to be put away in the warehousing sheet data have been put to corresponding storage locations on racks according to the result of the allocating, it is determined whether there is a difference between relevant information of items to be put away in the warehousing sheet data and relevant information of items that have been actually put away.

In step 430, a physical inspection of the items that have been put away is performed. For example, the WCS can return difference information about abnormal warehousing to the WMS.

In step 440, relevant information of the items on racks are uploaded and handled. For example, the WCS can return normal put-away completion information to the WMS, and the WMS receives the put-away information and processes this information.

In some embodiments, the WMS performs special difference processing (such as physical inventory) for abnormal put-away information; the WMS performs normal put-away information processing (such as updating relevant information of corresponding items) for the normal put-away completion information.

In the above embodiment, items to be warehoused are divided into a plurality of tasks according to their logistics storage attributes, and according to at least one of a shelf life parameter, a category parameter, or a weight parameter, storage locations are allocated for the item to be warehoused in the tasks according to the arrangement sequence of storage locations in a storage area. In this way, storage locations can be reasonably allocated according to item attributes, thereby improving warehousing efficiency.

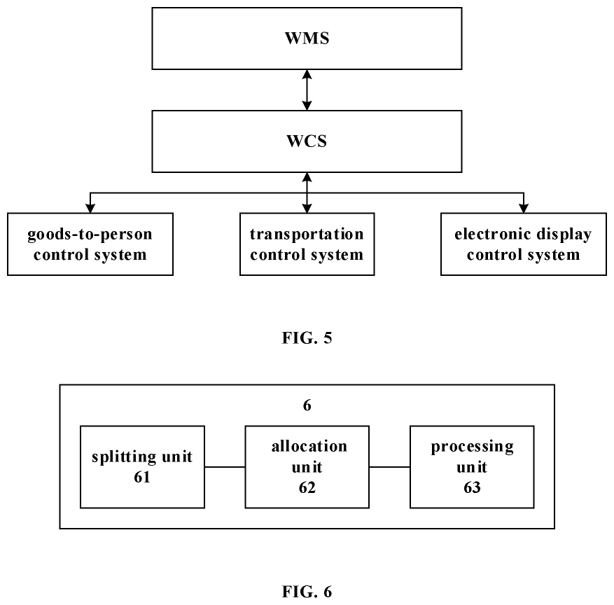

FIG. 5 shows a schematic diagram of an item warehousing device according to some embodiments of the present disclosure.

As shown in FIG. 5, the warehousing device may comprise a WCS for the splitting of worksheets and allocating storage locations. The warehousing device may further comprise a WMS for generating and issuing warehousing sheet data, and performing data interaction with the WCS to update the relevant information of each item.

In some embodiments, the warehousing device may further comprise a goods-to-person control system (goods-to-person system). For example, the goods-to-person control system may comprise a rotating rack system comprising a rotating rack frame, rack units, a drive motor, a transmission device, weight sensors, and a protective net.

For example, the rotating rack system can be disposed in a freeze area (such as, with a typical temperature of −18° C.) for storage and rotational movement of items. The rack units can be fixed on the transmission device driven by the drive motor, thereby realizing the rotation of the racks. A rack unit can contain several shelves, which divide the rack into several layers for storing items. Each layer can be provided with several storage locations for the storage of different categories of items.

For example, a weight sensor can detect the weight of items on the rack in the put-away process, and can be used to check the number of items that have been put away. In this way, put-away detection can be completed without manual counting operation, thereby improving the put-away efficiency.

In some embodiments, the warehousing device may further comprise a transportation control system for realizing the transportation of empty bins and bins with items.

In some embodiments, the warehousing device may further comprise an electronic display system. For example, the electronic display system comprises several display screens arranged on automatic doors. The rotating racks of each storage lane can correspond to an automatic door and an electronic display screen, which is used to prompt the logistics attribute information of items to be put away, and to carry out corresponding operations.

In some embodiments, the transportation system and electronic display system are located within an operating room. The operating room is isolated by several thermal insulation walls, and the temperature in the operating room is relatively comfortable (usually 5˜10V). In this way, operators can carry out related warehousing operations under a comfortable ambient temperature. Therefore, through improving the operators' working environment, working efficiency can be improved.

In some embodiments, the warehousing device may further comprise an air curtain disposed above the automatic door. Whenever the automatic door is opened, the air curtain is turned on in advance; the air curtain is tuned off after the automatic door is closed for a certain period of time. In this way, the cold air in the freezer where the rotating rack system is located can be prevented from entering the operating room, so as to ensure the temperature and humidity in the operating room, and avoid damage to the equipment caused by condensation in the operating room.

FIG. 6 shows a block diagram of the item warehousing device according to some embodiments of the present disclosure.

As shown in FIG. 6, the item warehousing device 6 comprises a splitting unit 61, an allocation unit 62 and a processing unit 63.

The splitting unit is used for, in response to receiving warehousing sheet data, splitting the warehousing sheet data into a plurality of worksheets according to logistics storage attributes of various items to be warehoused in the warehousing sheet data.

The allocation unit 62 is used for, according to at least one of a shelf life parameter, a category parameter, or a weight parameter, and according to an arrangement sequence of storage locations in a storage area, allocating storage locations for the items to be warehoused in each worksheet of the plurality of worksheets.

In some embodiments, the allocation unit 62 is used for, according to relevant data of warehoused items, for each item to be warehoused, searching for a matched warehoused item matching the shelf life parameter of the item to be warehoused; and allocating a storage location where the matched warehoused item is located to the corresponding item to be warehoused.

In some embodiments, the allocation unit 62 is used for, according to relevant data of warehoused items, for each item to be warehoused, searching for a matched warehoused item matching the category parameter of the item to be warehoused; and allocating a storage location where the matched warehoused item is located to the corresponding item to be warehoused.

In some embodiments, the allocation unit 62 is used for, for each item to be warehoused, determining specific gravity information of the item to be warehoused according to a weight parameter and package size information of the item to be warehoused; allocating a storage location for the item to be warehoused according to the specific gravity information.

In some embodiments, the storage area comprises a plurality of sequentially arranged sub-storage areas, and the sub-storage area comprises a plurality of sequentially arranged storage lanes. The allocation unit 62 is used for, for each item to be warehoused, according to the category parameter of the item to be warehoused, determining a matched warehoused item matching the item to be warehoused; if the storage locations in a storage lane where the matched warehoused item is located are not full, allocating a storage location in the storage lane where the matched warehoused item is located to the corresponding item to be warehoused; if the storage locations in the storage lane where the matched warehoused item is located are all full, according to the arrangement of the sub-storage areas, allocating a storage location in a storage lane of another sub-storage area to the corresponding item to be warehoused.

In some embodiments, if the storage locations in a storage lane with the same sequence number as the storage lane where the matched warehoused item is located are not full, the allocation unit 62 allocates a storage location in the storage lane with the same sequence number to the corresponding item to be warehoused; if the storage locations in the storage lane with the same sequence number as the storage lane where the matched warehoused item is located are all full, allocates a storage location to the item to be warehoused according to the arrangement sequence of the sub-storage areas and the arrangement sequence of the storage lanes.

In some embodiments, a storage area comprises a plurality of sequentially arranged sub-storage areas, each sub-storage area of the plurality of sequentially arranged sub-storage areas comprising a plurality of sequentially arranged storage lanes, and each storage lane comprising a plurality of sequentially arranged racks. The allocation unit 62 is used for allocating a storage location to the item to be warehoused according to the arrangement sequence of the racks.

In some embodiments, the rack in the storage area has a plurality of layers. The allocation unit 62 is used for allocating a storage location for the item to be warehoused according to priorities of the plurality of layers, wherein layers closer to the middle of the rack have higher priorities than those farther from the middle of the rack.

The processing unit 63 is used for, according to the result of the allocating, performing a warehousing process on items to be warehoused in the warehousing sheet.

In some embodiments, the processing unit 63 is used for, for each worksheet of the plurality of worksheets, according to the result of the allocating, putting items to be warehoused in the worksheet to corresponding storage locations on a rack; for each item category in the worksheet, obtaining an actual weight of items of this category on the rack through a weight sensor; according to the obtained actual weight, determining a quantity of warehoused items of this category; if the quantity of warehoused items is less than a registered quantity of the corresponding category in the corresponding worksheet, determining extra items in the corresponding category in the corresponding worksheet data as new items to be warehoused; re-allocating a storage location for the new items to be warehoused.

In some embodiments, the processing unit 63 is used for, according to the result of the allocating, putting items to be warehoused of each category in the warehousing sheet data to a corresponding storage location for the category on a rack; for each item category in the warehousing sheet data, obtaining an actual weight of items of this category on the rack through a weight sensor; according to the obtained actual weight, determining a quantity of the warehoused items of this category; if the quantity of the warehoused items is less than a registered quantity of the corresponding category in the warehousing sheet data, determining extra items in the warehousing sheet as items that have not been put away; according to the result of the allocating, putting the items that have not been put away to a corresponding storage location on the rack.

In some embodiments, the processing unit 63 is used for, according to the result of the allocating, putting items to be warehoused in the warehousing sheet data to corresponding storage locations on a rack; for each item on the rack, if there is a difference between relevant information of the item on the rack and relevant information of a corresponding item to be warehoused in the warehousing sheet data, checking the items on the rack; if there is not a difference between relevant information of the item on the rack and relevant information of a corresponding item to be warehoused in the warehousing sheet data, uploading the relevant information of the items on the rack.

In some embodiments, the logistical storage attributes comprise at least one of an item storage temperature parameter or a package size parameter.

In some embodiments, the processing unit 63 controls a transmission device to drive a rack to rotate, so as to store the items to be warehoused to their corresponding storage locations on the rack.

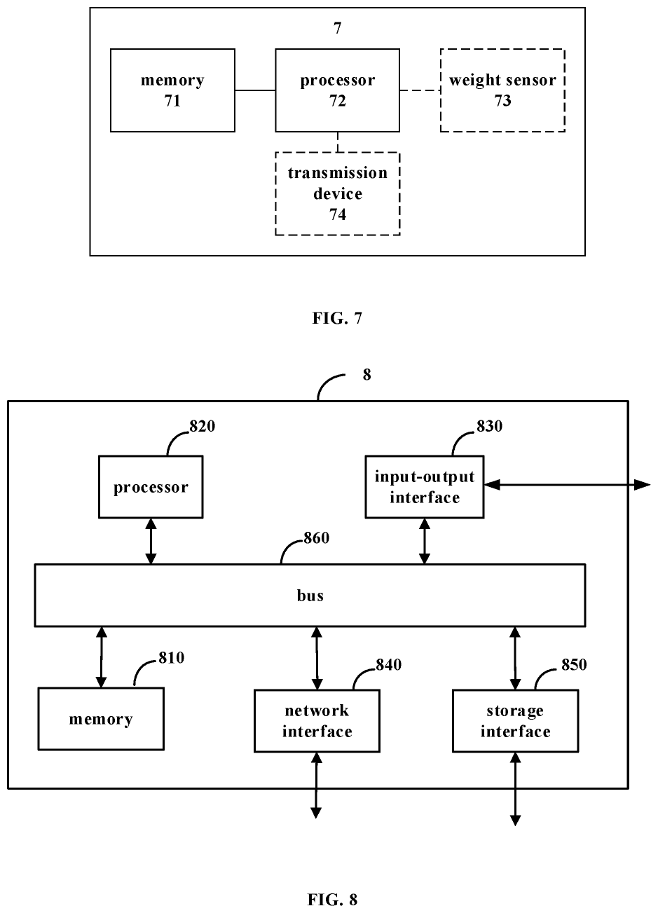

FIG. 7 shows a block diagram of the item warehousing device according to other embodiments of the present disclosure.

As shown in FIG. 7, the item warehousing device 7 of this embodiment comprises: a memory 71 and a processor 72 coupled to the memory 71, the processor 72 configured to, based on instructions stored in the memory 71, carry out the item warehousing method according to any one of the embodiments of the present disclosure.

Wherein, the memory 71 may comprise, for example, system memory, a fixed non-transitory storage medium, or the like. The system memory stores, for example, an operating system, applications, a boot loader, a database, and other programs.

In some embodiments, the warehousing device 7 further comprises: a weight sensor 73 for detecting an actual weight of an item on a rack.

In some embodiments, the warehousing device 7 further comprises: a transmission device 74 for, in response to the control of a processor, driving a rack to rotate, so as to store the items to be warehoused to their corresponding storage locations on the rack.

FIG. 8 shows a block diagram of the item warehousing device according to still other embodiments of the present disclosure.

As shown in FIG. 8, the item warehousing device 8 of this embodiment comprises: a memory 810 and a processor 820 coupled to the memory 810, the processor 820 configured to, based on instructions stored in the memory 810, carry out the item warehousing method according to any one of the foregoing embodiments.

The memory 810 may comprise, for example, system memory, a fixed non-transitory storage medium, or the like. The system memory stores, for example, an operating system, application programs, a boot loader, and other programs.

The item warehousing device 8 may further comprise an input-output interface 830, a network interface 840, a storage interface 850, and the like. These interfaces 830, 840, 850 and the memory 810 and the processor 820 may be connected to each other through a bus 860, for example. Wherein, the input-output interface 830 provides a connection interface for input-output devices such as a display, a mouse, a keyboard, and a touch screen. The network interface 840 provides a connection interface for various networked devices. The storage interface 850 provides a connection interface for external storage devices such as an SD card and a USB flash disk.

Those skilled in the art should understand that the embodiments of the present disclosure may be provided as a method, a system, or a computer program product. Therefore, embodiments of the present disclosure can take the form of an entirely hardware embodiment, an entirely software embodiment or an embodiment containing both hardware and software elements. Moreover, the present disclosure may take the form of a computer program product embodied on one or more computer-usable non-transitory storage media (comprising but not limited to disk storage, CD-ROM, optical storage device, etc.) having computer-usable program code embodied therein.

Heretofore, the item warehousing method, the item warehousing device, and the non-transitory computer-readable storage medium according to the present disclosure have been described in detail. In order to avoid obscuring the concepts of the present disclosure, some details known in the art are not described. Based on the above description, those skilled in the art can understand how to implement the technical solutions disclosed herein.

The method and system of the present disclosure may be implemented in many ways. For example, the method and system of the present disclosure may be implemented by software, hardware, firmware, or any combination of software, hardware, and firmware. The above sequence of steps of the method is merely for the purpose of illustration, and the steps of the method of the present disclosure are not limited to the above-described specific order unless otherwise specified. In addition, in some embodiments, the present disclosure may also be implemented as programs recorded in a recording medium, which comprise machine-readable instructions for implementing the method according to the present disclosure. Thus, the present disclosure also covers a recording medium storing programs for executing the method according to the present disclosure.

Although some specific embodiments of the present disclosure have been described in detail by way of example, those skilled in the art should understand that the above examples are only for the purpose of illustration and are not intended to limit the scope of the present disclosure. It should be understood by those skilled in the art that the above embodiments may be modified without departing from the scope and spirit of the present disclosure. The scope of the disclosure is defined by the following claims.

1. An item warehousing method, comprising:
splitting warehousing sheet data into a plurality of worksheets, in response to receiving the warehousing sheet data, according to logistics storage attribute of items to be warehoused in the warehousing sheet data;
allocating storage locations for the items to be warehoused in each worksheet of the plurality of worksheets, according to at least one of a shelf life parameter, a category parameter, or a weight parameter, and according to an arrangement sequence of storage locations in a storage area; and
performing a warehousing process on the items to be warehoused in the warehousing sheet data, according to a result of the allocating.

2. The warehousing method according to claim 1, wherein allocating storage locations for the items to be warehoused in each worksheet of the plurality of worksheets comprises:
searching for a matched warehoused item matching the shelf life parameter of the items to be warehoused, according to relevant data of warehoused items; and
allocating a storage location where the matched warehoused item is located to an item to be warehoused corresponding to the matched warehoused item.

3. The warehousing method according to claim 1, wherein allocating storage locations for the items to be warehoused in each worksheet of the plurality of worksheets comprises:
searching for a matched warehoused item matching the category parameter of the items to be warehoused, according to relevant data of warehoused items; and
allocating a storage location where the matched warehoused item is located to an item to be warehoused corresponding to the matched warehoused item.

4. The warehousing method according to claim 1, wherein allocating storage locations for the items to be warehoused in each worksheet of the plurality of worksheets comprises:
determining specific gravity information of the items to be warehoused, according to a weight parameter and package size information of the items to be warehoused; and
allocating storage locations for the items to be warehoused according to the specific gravity information.

5. The warehousing method according to claim 4, wherein the storage area comprises a plurality of sequentially arranged sub-storage areas, and each sub-storage area of the plurality of sequentially arranged sub-storage areas comprises a plurality of sequentially arranged storage lanes, and
the allocating storage locations for the items to be warehoused in each worksheet of the plurality of worksheets comprises:
determining a matched warehoused item matching the items to be warehoused, according to the category parameter of the items to be warehoused;
allocating a storage location in a storage lane where the matched warehoused item is located to an item to be warehoused corresponding to the matched warehoused item, in case that storage locations in the storage lane where the matched warehoused item is located are not full; and
allocating a storage location in a storage lane of another sub-storage area to the item to be warehoused corresponding to the matched warehoused item, according to arrangement of the sub-storage areas, in a case where storage locations in the storage lane where the matched warehoused item is located are all full.

6. The warehousing method according to claim 5, wherein allocating a storage location in a storage lane of another sub-storage area to the item to be warehoused corresponding to the matched warehoused item comprises:
allocating a storage location in a storage lane with the same sequence number to the item to be warehoused corresponding to the matched warehoused item, in a case where storage locations in the storage lane with the same sequence number as the storage lane where the matched warehoused item is located are not full; and
allocating a storage location to the item to be warehoused according to arrangement sequence of sub-storage areas and arrangement sequence of storage lanes, in a case where the storage locations in the storage lane with the same sequence number as the storage lane where the matched warehoused item is located are all full.

7. The warehousing method according to claim 1, wherein the storage area comprises a plurality of sequentially arranged sub-storage areas, each sub-storage area of the plurality of sequentially arranged sub-storage areas comprises a plurality of sequentially arranged storage lanes, and each storage lane comprises a plurality of sequentially arranged racks, and
allocating storage locations for the items to be warehoused in each worksheet of the plurality of worksheets comprises:
allocating a storage location for the item to be warehoused according to the arrangement sequence of racks.

8. The warehousing method according to claim 1, wherein a rack in the storage area comprises a plurality of layers,
allocating storage locations for the items to be warehoused in each worksheet of the plurality of worksheets comprises:
allocating a storage location for the item to be warehoused according to priorities of the plurality of layers, wherein layers closer to the middle of the rack have higher priorities than those farther from the middle of the rack.

9. The warehousing method according to claim 1, wherein performing a warehousing process on the items to be warehoused in the warehousing sheet data, according to a result of the allocating comprises:
putting the items to be warehoused in each worksheet of the plurality of worksheets to storage locations on a rack, according to a result of the allocating;
obtaining an actual weight of at least one item belonging to a category on the rack through a weight sensor;
determining a quantity of warehoused items belonging to the category in each worksheet of the plurality of worksheets, according to an obtained actual weight;
determining an extra item of the category in a worksheet corresponding to the quantity of warehoused items as a new item to be warehoused, in a case where the quantity of warehoused items is less than a registered quantity of the category in the worksheet corresponding to the quantity of warehoused items; and
re-allocating a storage location for the new item to be warehoused.

10. The warehousing method according to claim 1, wherein performing a warehousing process on the items to be warehoused in the warehousing sheet data, according to a result of the allocating comprises:
putting the items to be warehoused belonging to a category in the warehousing sheet data to a storage location corresponding to the category on a rack, according to a result of the allocating;
obtaining an actual weight of at least one item of the category on the rack in the warehousing sheet data through a weight sensor;
determining a quantity of warehoused items belonging to the category in each worksheet of the plurality of worksheets, according to an obtained actual weight;
determining an extra item of the category in a worksheet as an item that has not been on the rack, in a case where the quantity of warehoused items belonging to the category is less than a registered quantity of items belonging to the category in the warehousing sheet data; and
putting the item that has not been on the rack to a storage location corresponding to the item that has not been on the rack, according to a result of the allocating.

11. The warehousing method according to claim 1, wherein performing a warehousing process on the items to be warehoused in the warehousing sheet data, according to a result of the allocating comprises:
putting the items to be warehoused in the warehousing sheet data to storage locations corresponding to the items to be warehoused on a rack, according to a result of the allocating;
checking an item on the rack, in a case where there is a difference between relevant information of the item on the rack and relevant information of an item to be warehoused in the warehousing sheet data corresponding to the item on the rack; and
uploading relevant information of an item on the rack, in a case where there is not a difference between relevant information of the item on the rack and relevant information of an item to be warehoused in the warehousing sheet data corresponding to the item on the rack.

12. The warehousing method according to claim 1, wherein the logistical storage attributes comprise at least one of an item storage temperature parameter or a package size parameter.

13. The warehousing method according to claim 1, wherein performing a warehousing process on the items to be warehoused in the warehousing sheet data, according to a result of the allocating comprises:
controlling a transmission device to drive a rack to rotate to store the items to be warehoused in their corresponding storage locations on a rack.

14. (canceled)

15. An item warehousing device, comprising:
a memory; and
a processor coupled to the memory, the processor configured to, based on instructions stored in the memory, carry out the following steps of:
splitting warehousing sheet data into a plurality of worksheets, in response to receiving the warehousing sheet data, according to logistics storage attribute of items to be warehoused in the warehousing sheet data;
allocating storage locations for the items to be warehoused in each worksheet of the plurality of worksheets, according to at least one of a shelf life parameter, a category parameter, or a weight parameter, and according to an arrangement sequence of storage locations in a storage area; and
performing a warehousing process on the items to be warehoused in the warehousing sheet data, according to a result of the allocating.

16. The warehousing device according to claim 15, further comprising:
a weight sensor for detecting an actual weight of an item on a rack.

17. The warehousing device according to claim 15, further comprising:
a transmission device for, driving a rack to rotate, in response to a control of the processor, to store items to be warehoused to their corresponding storage locations on a rack.

18. A non-transitory computer-readable storage medium on which a computer program is stored, which when executed by a processor implements the following steps of:
splitting warehousing sheet data into a plurality of worksheets, in response to receiving the warehousing sheet data, according to logistics storage attribute of items to be warehoused in the warehousing sheet data;
allocating storage locations for the items to be warehoused in each worksheet of the plurality of worksheets, according to at least one of a shelf life parameter, a category parameter, or a weight parameter, and according to an arrangement sequence of storage locations in a storage area; and
performing a warehousing process on the items to be warehoused in the warehousing sheet data, according to a result of the allocating.
